(19) United States
(12) Patent Application Publication
(10) Pub. No.: US 2025/0370677 A1
(43) Pub. Date: Dec. 4, 2025

(54) INFORMATION PROCESSING APPARATUS AND SETTING METHOD

(71) Applicant: SHARP KABUSHIKI KAISHA, Osaka (JP)

(72) Inventor: YUUKI MASUI, Osaka (JP)

(21) Appl. No.: 19/220,654

(22) Filed: May 28, 2025

(30) Foreign Application Priority Data
Jun. 4, 2024 (JP) 2024-090613

(51) Int. Cl. G06F 3/12

(52) U.S. Cl. CPC G06F 3/1257; G06F 3/1204; G06F 3/1258

(57) ABSTRACT

An information processing apparatus includes a display, one or more storages that store a setting item and a setting value in an associated manner; and one or more controllers that acquire a setting value corresponding to the setting item from an external storage apparatus to set the acquired setting value to the setting value stored in the one or more storages. In a case where the setting value corresponding to a specific setting item of the setting item stored in the one or more storages are not yet set, the one or more controllers cause the display to display a setting screen used to set the setting value that is not yet set.

### TECHNICAL FIELD

The present disclosure relates to an information processing apparatus and a setting method.

### BACKGROUND ART

For example, an information processing apparatus is known. In a case where, after a specific setting value is set in updated firmware, a setting value of firmware prior to importing is not changed into an appropriate setting value, the information processing apparatus makes notification of a result of importing of the setting value.

### SUMMARY

### Technical Problem

The present disclosure relates, for example, to an information processing apparatus that needs initial setting, and one object of the present disclosure is to provide an information processing apparatus and a setting method that improve usability of the initial setting.

### Solution to Problem

An information processing apparatus according to the present disclosure includes: a display; one or more storages that store a setting item and a setting value in an associated manner; and one or more controllers that acquire a setting value corresponding to the setting item from an external storage device to set the acquired setting value to the setting value stored in the one or more storages, in which, in a case where the setting value corresponding to a specific setting item of the setting item stored in the one or more storages are not yet set, the one or more controllers cause the display to display a setting screen used to set the setting value that is not yet set.

A setting method according to the present disclosure includes: a displaying step; a storing step of storing a setting item and a setting value in an associated manner; and a controlling step of acquiring a setting value corresponding to the setting item from an external storage device to set the acquired setting value to the setting value stored in the storing step, in which, in the controlling step, in a case where the setting value corresponding to a specific setting item of the setting item stored during the storing step is not yet set, a setting screen used to set the setting value that is not yet set is displayed in the displaying step.

### Advantageous Effects of Disclosure

With the present disclosure, for an information processing apparatus that needs an initial setting, it is possible to provide an information processing apparatus and a setting method that improve usability of the initial setting, for example.

### BRIEF DESCRIPTION OF THE DRAWINGS

FIG. 1 is a diagram used to describe the overview of a system according to a first embodiment.

FIG. 2 is a diagram used to describe the configuration of hardware according to the first embodiment.

FIGS. 3A and 3B are diagrams used to describe the software configuration according to the first embodiment.

FIG. 4A is a diagram used to describe one example of a system setting information according to the first embodiment. FIG. 4B is a diagram used to describe one example of job setting information according to the first embodiment. FIG. 4C is a diagram used to describe one example of setting information according to the first embodiment.

FIG. 5 is a diagram used to describe a flow of a main process according to the first embodiment.

FIG. 6 is a diagram used to describe a flow of a yet-to-be-set determination process according to the first embodiment.

FIGS. 7A to 7D are diagrams used to describe an operation example according to the first embodiment.

FIGS. 8A and 8B are diagrams used to describe an operation example according to the first embodiment.

FIG. 9 is a diagram used to describe the software configuration according to a second embodiment.

FIG. 10 is a diagram used to describe one example of non-recommended setting information according to the second embodiment.

FIG. 11 is a diagram used to describe a flow of a non-recommendation determination process according to the second embodiment.

FIGS. 12A and 12B are diagrams used to describe an operation example according to the second embodiment.

FIG. 13 is a diagram used to describe the software configuration according to a third embodiment.

FIG. 14 is a diagram used to describe a flow of a password determination process according to the third embodiment.

FIGS. 15A to 15D are diagrams used to describe an operation example according to the third embodiment.

### DETAILED DESCRIPTION OF THE INVENTION

Generally, in an information processing apparatus, various types of settings for the information processing apparatus are performed at a controller. As setting information, the controller stores, in a storage, information used to perform various types of settings. The information processing apparatus can be provided in various types of devices, and can be provided in a device that performs processing on the basis of a large number of settings, for example, an image forming apparatus such as a multifunction peripheral/printer/product (MFP). The image forming apparatus including the information processing apparatus requires a user to set a large number of items as initial settings at the time of the first startup of the image forming apparatus that is in a state of factory settings.

When many items are set in this manner, this setting operation imposes a load on a user. Here, for example, when a user stores setting information of the existing image forming apparatus in an external storage device, the user can cause a newly purchased image forming apparatus to read the setting information to perform the initial setting. By performing the initial setting through such importing, the user can easily complete the initial setting.

However, in some cases, it is not possible to correctly reflect the setting information imported from the external storage device on setting information of an image forming apparatus due to different product models or different versions. In addition, only with the setting information imported from the external storage device, there is a possibility of occurrence of a problem in which essential setting items are left not being set, or a non-recommended setting value is set, or the like. For example, when the image forming apparatus notifies the user that there is a certain problem in the imported setting information, the user needs to check the notifications one by one. Here, for example, if the user overlooks the notification, there is a problem in that the setting is omitted or the operation is performed with the non-recommended setting value.

Below, the information processing apparatus that solves such problems will be described in the following embodiments with reference to the drawings. Note that the disclosure set forth in the claims will be described in the embodiments below as one example, and the technical scope of the present disclosure is not limited to the following description.

### 1. First Embodiment

Below, a first embodiment will be described. Note that, in the first embodiment, the following description will be made as one example. The embodiment below describes a case where an information processing apparatus according to the present disclosure is applied to an image forming apparatus. However, the information processing apparatus can be applied to a device other than the image forming apparatus.

### 1.1 ENTIRE SYSTEM

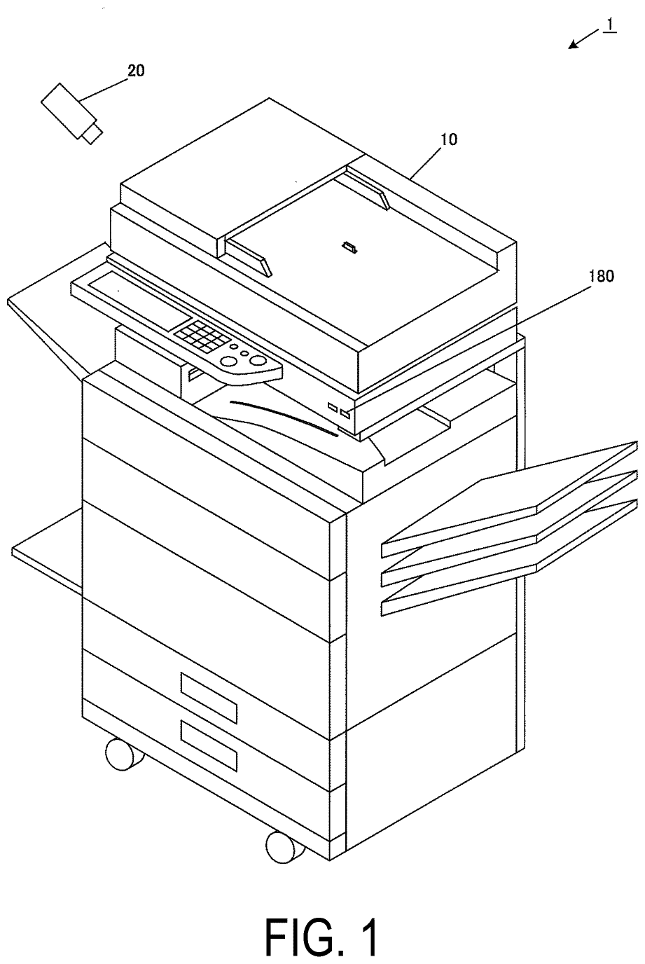

FIG. 1 is a diagram used to describe the overview of a system 1 including an image forming apparatus 10 and an external storage device 20.

The image forming apparatus 10 is, for example, a device called a multi-function printer or an MFP. For example, by performing a job (printing job), the image forming apparatus 10 can form an image on paper serving as a recording medium. As for the jobs to be performed, the image forming apparatus 10 can perform a plurality of processes of jobs that include a copying process, a FAX process, a scanning process, and a printing process. The image forming apparatus 10 includes an interface (I/F) unit 180, and can be coupled to various types of external devices, for example, through a Universal Serial Bus (USB) port or the like.

The external storage device 20 may be, for example, a portable storage device (removable storage) such as a USB flash drive, a portable hard disk drive (HDD), or a portable solid state drive (SSD). The external storage device 20 employs, for example, a standard that can be used as a storage bus such as USB, serial advanced technology attachment (ATA), a non-volatile memory host controller interface (NVMHCI), or the like. In addition, in a case of a USB flash drive, the external storage device 20 is inserted into a USB port to be coupled to the image forming apparatus 10, for example.

In addition, the network (NW) that couples the image forming apparatus 10 is only necessary to any communication line or communication system. For example, it may be possible to use a communication system such as a local area network (LAN), a virtual local area network (VLAN), the Internet, a public line network, mobile communication (for example, mobile communication such as 4G/5G/6G), a next generation telecommunication network, or the like using wired line or wireless.

### 1.2 HARDWARE CONFIGURATION

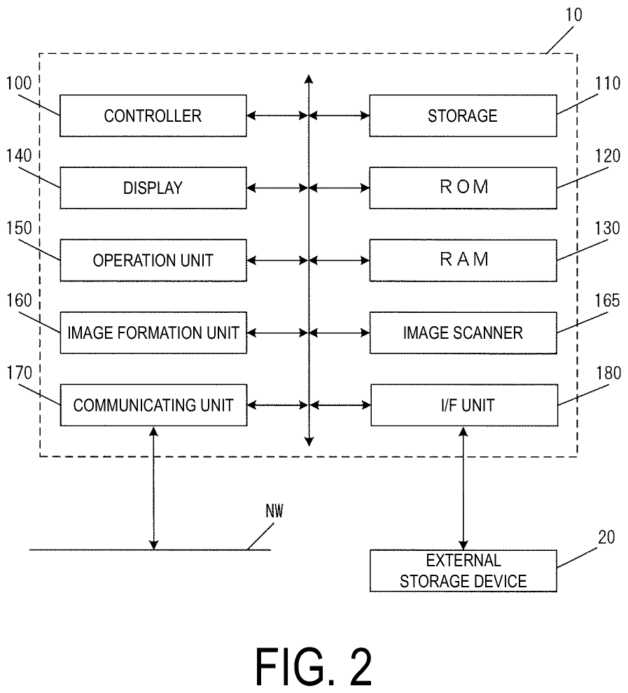

Of the devices included in the system 1, the hardware configuration of the image forming apparatus 10 will be described below as a typical device with reference to the drawings. FIG. 2 is a diagram illustrating one example of the image forming apparatus 10.

As illustrated in FIG. 2, the image forming apparatus 10 includes a controller 100. In addition, the image forming apparatus 10 includes a storage 110, a read only memory (ROM) 120, and a random access memory (RAM) 130 each serving as a storage device (storage), and also includes a display 140, an operation unit 150, an image formation unit 160, an image scanner 165, a communicating unit 170, and an I/F unit 180.

The controller 100 controls the entire image forming apparatus 10. The controller 100 reads and performs various types of programs stored in the storage device (for example, the storage 110 and the ROM 120) to implement various types of functions. The controller 100 may be achieved by one or multiple control devices/arithmetic devices (such as a central processing unit (CPU), a system on a chip (SoC)). In addition, the controller 100 may include one or multiple control circuits.

The storage 110 is a non-volatile storage device capable of storing programs and data. For example, the storage 110 may be configured by one or multiple storage devices such as an HDD or SSD. Furthermore, the storage 110 may be configured as an external device such as a USB flash drive that can be coupled to the image forming apparatus 10. In addition, the storage 110 may be, for example, a storage region on a cloud.

The ROM 120 is a non-volatile memory capable of holding the program and data even in a case where the power is turned off.

The RAM 130 is a main memory mainly used when the controller 100 executes processing. The RAM 130 is a rewritable memory that temporarily holds a program read from the storage 110 or the ROM 120 and data including an execution result.

The display 140 is a display device that can display various types of information and various types of screens such as an execution screen. The display 140 may be, for example, a display device such as a liquid crystal display (LCD), an organic electro-luminescence (EL) display, an electrophoresis display, or the like. In addition, the display 140 includes an interface to which the display device can be coupled. For example, the display 140 may include an external display device coupled via a high-definition multimedia interface (HDMI) (trade name), a digital visual interface (DVI), or a display port.

The operation unit 150 is an operation device that makes it possible to receive an input operation from a user. For example, the operation unit 150 may be software keys displayed on a touch panel integrated with the display 140 or hardware keys such as operation buttons. In addition, the operation unit 150 may be an operation device such as a keyboard or a mouse. Furthermore, the operation unit 150 may also include an interface (for example, a USB) to which an operation device can be coupled. For example, the image forming apparatus 10 may be coupled to different operation devices (a keyboard, a mouse, and the like) via an interface.

The image formation unit 160 forms an image on, for example, a recording sheet. The image formation unit 160 includes, for example, an image carrier. The image formation unit 160 forms a toner image on the image carrier, and transfers the toner image on the image carrier onto the recording sheet, thereby forming an image. The image formation unit 160 may be configured as an image forming apparatus such as a printer. In addition, the image formation unit 160 may electronically form an image as an image file.

The image scanner 165 reads a document (image) and outputs the document as image data. The image scanner 165 may be, for example, a scanner, or may be a reading device using a charge coupled device (CCD), a contact image sensor (CIS), or a complementary metal-oxide-semiconductor (CMOS) image sensor.

The communicating unit 170 is a communication interface that communicates with other devices. The communicating unit 170 may be, for example, a network interface capable of providing wired connection or wireless connection. In the present embodiment, communication with other devices is possible via a network NW.

The I/F unit 180 is an external bus interface coupled to various types of external devices. For example, the I/F unit 180 may be a serial bus interface or a multi-bus interface that can be coupled to a mouse, a keyboard, or the like. In the present embodiment, the I/F unit 180 can be coupled to the external storage device 20 via a USB port.

The external storage device 20 is an external storage device such as a general USB flash drive, and hence, detailed explanation thereof will not be provided. For example, the external storage device 20 includes, for example, at least a controller, a storage (storage, ROM, and RAM), and an I/F unit.

### 1.3 SOFTWARE CONFIGURATION

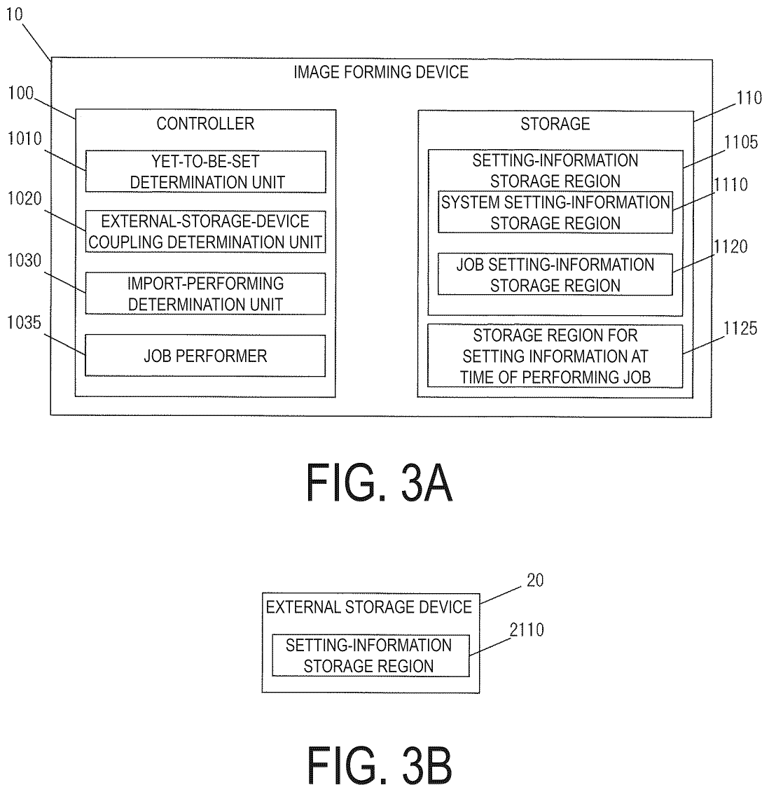

The main software configuration of each of the devices included in the system 1 will be described with reference to FIGS. 3A and 3B. FIG. 3A is a diagram illustrating the software configuration of the image forming apparatus 10. FIG. 3B is a diagram illustrating the main software configuration of the external storage device 20. Note that the software configurations illustrated in FIGS. 3A and 3B are main configurations necessary in the present embodiment, and the other configurations are not illustrated.

### 1.3.1 Image Forming Apparatus

First, the main software configuration of the image forming apparatus 10 will be described. For example, the controller 100 reads programs stored in the storage (the storage 110 or the ROM 120) to perform the programs, thereby being able to achieve a yet-to-be-set determination unit 1010, an external-storage-device coupling determination unit 1020, an import-performing determination unit 1030, and a job performer 1035.

The yet-to-be-set determination unit 1010 determines, for example, whether a setting value corresponding to a setting item is not yet set. Here, the “not yet set” means that a setting value is not changed from an initial value, for example. In the following cases, the yet-to-be-set determination unit 1010 may determine that the setting value is not yet set, for example.
a case where a setting value such as “null” indicating “not yet set” is stored as the setting value
a case where the setting value is an initial value (default setting value)
a case where the setting value included in setting information acquired from the external storage device 20 is not changed from an initial value

The external-storage-device coupling determination unit 1020 determines, for example, whether or not the external storage device 20 is coupled to the I/F unit 180. For example, when receiving a certain signal from the I/F unit 180, the external-storage-device coupling determination unit 1020 may determine that the external storage device 20 is coupled to the I/F unit 180. In addition, the external-storage-device coupling determination unit 1020 may determine whether or not coupling of the external storage device 20 is released (removed), or may determine whether or not the external storage device 20 is coupled.

The import-performing determination unit 1030 determines, for example, whether or not a user selects importing. Here, the “importing” means that the image forming apparatus 10 reflects setting information acquired from the external storage device 20 through the I/F unit 180 on the setting information of the image forming apparatus 10. The import-performing determination unit 1030 may display, for example, a display screen (importing performing screen) that makes it possible to select performing importing and makes an inquiry about whether to perform importing, and may determine whether to perform importing.

The job performer 1035 performs various types of jobs. For example, the job performer 1035 can perform various types of jobs such as a copying job, a scanning job, and a printing job. When performing the job, the job performer 1035 can look up the job setting-information storage region 1120 for the initial setting of the job performance, and perform setting. Furthermore, in a storage region 1125 for the setting information at the time of performing a job, the job performer 1035 stores the setting at the time of performing the job as the setting information at the time of performing the job.

In addition, the storage 110 secures a region of the setting-information storage region 1105 for storing the setting information. The setting-information storage region 1105 stores setting information indicating setting of the image forming apparatus 10. The setting information includes system setting information that is information regarding settings in connection with the operation of the image forming apparatus 10, and also includes job setting information that is information on the initial setting concerning performing a job at the time when the image forming apparatus 10 performs the job. Furthermore, the system setting information is stored in a region of the system setting-information storage region 1110, and the job setting information is stored in a region of the job setting-information storage region 1120.

Here, the system setting information includes, for example, information that is looked up when the image forming apparatus 10 operates, which includes settings concerning a model name, date and time, security (for example, encryption type of a wireless LAN or the like), and a network (for example, information on an IP address, a gateway address, or the like), settings concerning an administrator password, and feed tray, or the like. In addition, the system setting information may include setting information concerning an energy saving setting, a language setting, and the brightness of the display as one example of the setting information used to operate the image forming apparatus 10. Furthermore, the system setting information may further include information on a property.

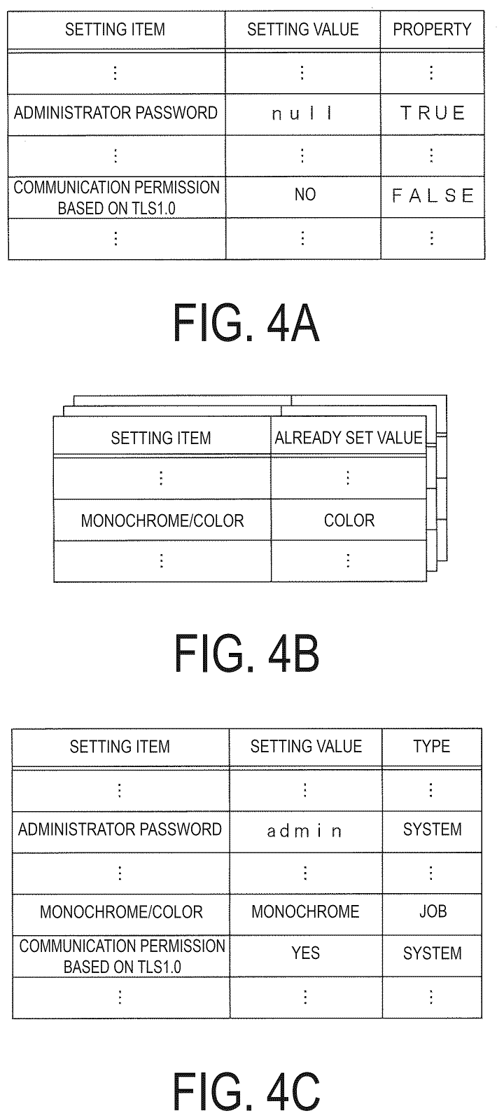

Here, one example of the system setting information stored in the system setting-information storage region 1110 will be described with reference to FIG. 4A. Setting items (for example, “administrator password”) concerning the system setting information of the image forming apparatus 10, setting values (for example, “null”), and a property (for example, “TRUE”) are stored.

Here, the property indicates whether the setting item is a “specific setting item” or other setting item. For example, it may be possible to employ a configuration in which “TRUE” is stored as the property in a case where the setting item indicates the specific setting item, and “FALSE” is stored in a case where the setting item indicates an item other than the “specific setting item.” Here, the specific setting item may be an essential item that is a setting item essential to the image forming apparatus 10, for example. The essential item is a setting item necessary for the image forming apparatus 10 to operate.

A specific example of the essential item may include setting items such as a shipment destination setting, a date setting, a network setting, an administrator password, or a language setting. In addition, although the setting value of the administrator password is not yet set (null), an initial value may be set, or “0” may be stored as a value indicating “not yet set,” for example.

Furthermore, the job setting information is initial setting information when the job performer 1035 of the image forming apparatus 10 performs a job, for example. Specifically, the job setting information is initial setting information that is looked up when each of the jobs such as a copying job, a FAX job, a scanning job, or a printing job is performed, and the setting item and the setting value are stored. One example of the job setting information includes setting information such as a sheet size, a copy magnification, or color/monochrome in a case of the setting information on a copying job. In addition, in a case of the setting information on the FAX job, the job setting information is setting information such as a resolution, communication speed, a communication type, or the name or telephone number of a caller.

Here, with reference to FIG. 4B, description will be made of one example of the job setting information stored in the job setting-information storage region 1120. A setting item (for example, “monochrome/color”) of the job setting information on the image forming apparatus 10 and a setting value (for example, “color”) are stored.

A setting value set when the job performer 1035 performs a job is stored in the storage region 1125 for the setting information at the time of performing a job. For example, the job performer 1035 sets an initial value on the basis of the setting value of the job setting included in the setting information read from the job setting-information storage region 1120, and stores a setting value at the time of performing the job in combination with the setting value of a job setting set by a user, in the storage region 1125 for the setting information at the time of performing a job. The setting information at the time of performing the job may remain a setting value (initial value) stored in the job setting information, or may be a setting value changed by the user, or may be a setting value newly set by the user.

### 1.3.2 External Storage Device

Next, the main software configuration of the external storage device 20 will be described.

The storage of the external storage device 20 secures a setting-information storage region 2110 that stores setting information. Here, for example, the setting information is information including the system setting information and the job setting information that the image forming apparatus 10 can use, and a setting item, a setting value, and a type are stored.

Here, one example of the setting information stored in the setting-information storage region 2110 will be described with reference to FIG. 4C. A setting item (for example, “administrator password”) that can be used by the image forming apparatus 10, a setting value (for example, “admin”), and a type (for example, “system”) are stored. Here, the type may be information including “system” indicating that the information is the system setting information and “job” indicating that the information is the job setting information, for example.

Note that, in the present embodiment, the type indicating that the information is the job setting information is “job.” However, this type may be set to “copy,” “FAX,” “scan,” “print,” or the like for each job, for example. Furthermore, it is only necessary that the setting-information storage region 2110 includes at least the setting value such as a fixed-length data file, and may store the setting item as necessary. In addition, the setting information may be stored in a markup language such as XML or the like, for example. In this case, the setting information may store information on the type using a property tag.

### 1.4 PROCESSING FLOW

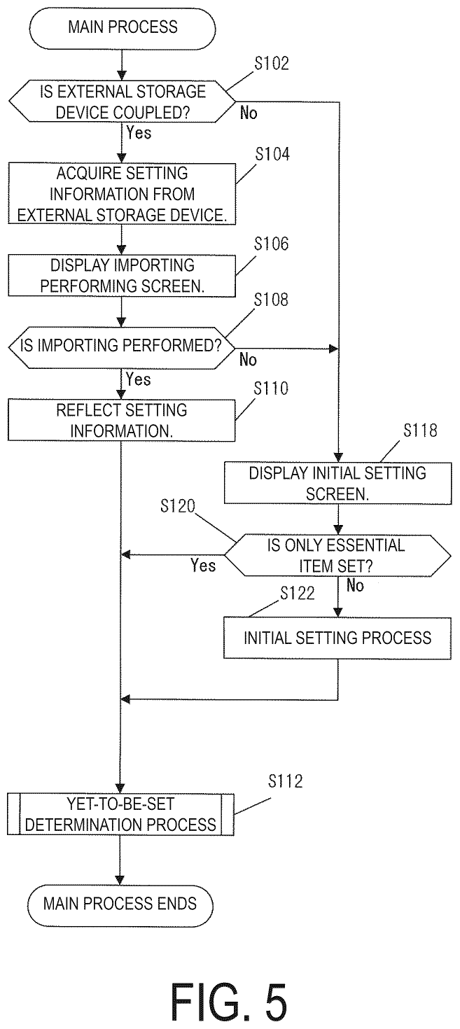

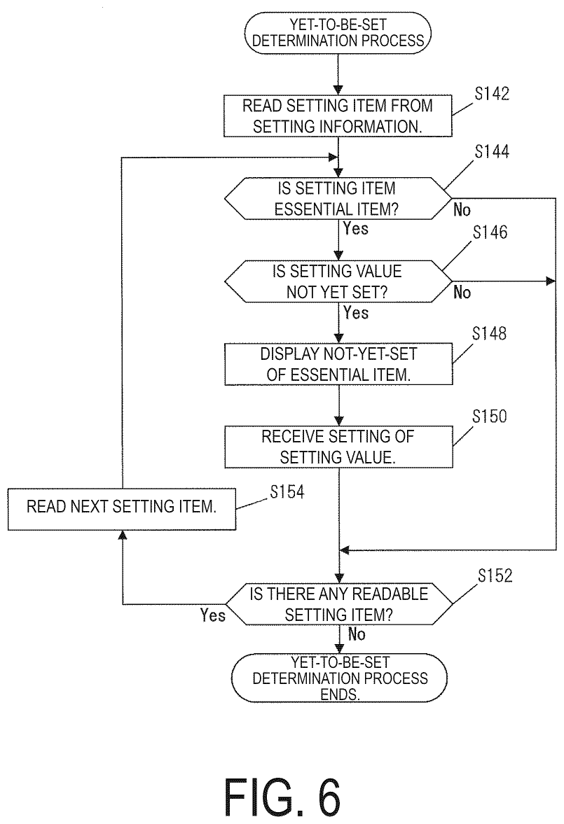

Below, the flow of processing in the present embodiment will be described with reference to FIGS. 5 and 6. Note that each of the configurations described with reference to FIGS. 2, 3A, and 3B may perform the processes of each step.

### 1.4.1 Main Process

FIG. 5 is a diagram illustrating the flow of the main process of the present embodiment.

First, the controller 100 determines whether or not the external storage device 20 is coupled (S102). When determining that the external storage device 20 is coupled, the controller 100 acquires the setting information from the external storage device 20 (S102; Yes→S104).

Next, the controller 100 displays an importing performing screen (S106). Then, the controller 100 determines whether to perform importing (S108).

Here, when determining that importing is performed, the controller 100 reflects the setting information acquired from the external storage device 20 on the setting information stored in the setting-information storage region 1105 (S108; Yes→S110). Here, the controller 100 reads a setting item stored in the system setting-information storage region 1110 or the job setting-information storage region 1120 on the basis of the type (for example, “system”) stored in the acquired setting information. Next, the controller 100 stores (reflects) the setting value included in the acquired setting information as the setting value stored for the setting item in the setting-information storage region 1105 that matches the setting item (for example, “administrator password”) stored in the acquired setting information.

Here, for example, in a case where the setting value in the acquired setting information is not appropriate (for example, in a case where data types do not match, the setting value is out of support, the setting value is a setting value for an unavailable configuration, or the like), the controller 100 may not store (reflect) the setting value included in the acquired setting information, in the setting-information storage region 1105.

Next, after performing importing from the external storage device 20 to reflect the setting information, the controller 100 performs a yet-to-be-set determination process in FIG. 6 (S112).

When determining that the external storage device 20 is not coupled (S102; No) or when determining that importing is not performed (S108; No), the controller 100 displays an initial setting screen (S118).

Next, the controller 100 determines whether only an essential item in the initial setting is set or all the setting items are set (S120). As for the determination method, the controller 100 may make determination through a selecting operation performed by a user, for example. When determining that the setting item is set only for an essential item of the setting items, the controller 100 performs the yet-to-be-set determination process (S120; Yes→S112).

On the other hand, when determining that all the setting items are set, the controller 100 performs an initial setting process (S120; No→S122). In the initial setting process, the controller 100 causes the display to display a setting item every time, thereby causing the user to input the setting value. The initial setting process may be achieved by a wizard screen for performing the initial setting or the like, for example.

The controller 100 stores the input setting value, as the setting information, in the setting information (the system setting information of the system setting-information storage region 1110 and/or the job setting-information storage region 1120) of the setting-information storage region 1105.

Then, the controller 100 performs the yet-to-be-set determination process to determine whether or not there is any not-yet-set setting item in essential setting items set in the initial setting process (S122→S112).

### 1.4.2 Yet-to-be-Set Determination Process

FIG. 6 is a diagram illustrating a flow of the yet-to-be-set determination process according to the present embodiment. The controller 100 reads a setting item from the setting information stored in the setting-information storage region 1105 (S142). The controller 100 may read information on the setting item, the setting value, and the property stored in the setting-information storage region 1105, for example. Specifically, the controller 100 may read a setting item from the system setting-information storage region 1110 and/or the job setting-information storage region 1120 as the setting-information storage region 1105, for example.

Next, the controller 100 determines whether or not the read setting item is an essential item (S144). For example, when the property read from the setting-information storage region 1105 (for example, the system setting information of the system setting-information storage region) is “TRUE,” the controller 100 determines that the corresponding setting item is an essential item.

When determining that the read setting item is an essential item, the controller 100 determines whether or not the setting value for this setting item has already been set (S144; Yes→S146). Note that, when determining that the read setting item is not an essential item, the controller 100 moves the process to step S152 that will be described below (S144; No→S152).

When determining that the setting value for the setting item that is the essential item has not yet been set, the controller 100 displays that the setting value for the setting item that is the required item has not yet been set (S146; Yes→S148). Here, the controller 100 displays an input screen for inputting this setting value that has not yet been set. Note that when determining that the setting value for the setting item that is the essential item has not yet been set, the controller 100 moves the process to step S152 that will be described below (S146; No→S152).

Next, the controller 100 receives a setting of the setting value input in S148 (S150). With this operation, the controller 100 stores the input setting value in the setting value corresponding to the setting item in the setting-information storage region 1105.

Next, the controller 100 determines whether or not there is any readable setting item (S152). When determining that there is no readable setting item, the controller 100 ends the yet-to-be-set determination process (S152; No). On the other hand, when determining that there is a readable setting item, the controller 100 reads the next setting item (S152; Yes→S154).

### 1.5 Operation Examples

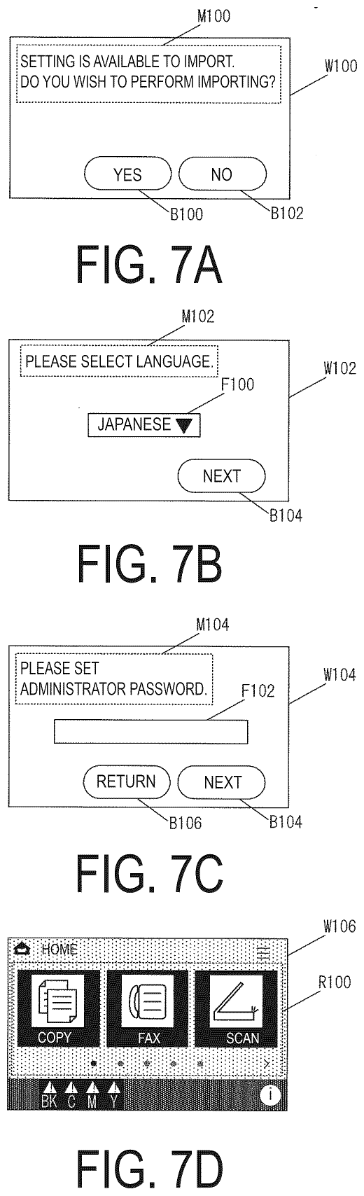

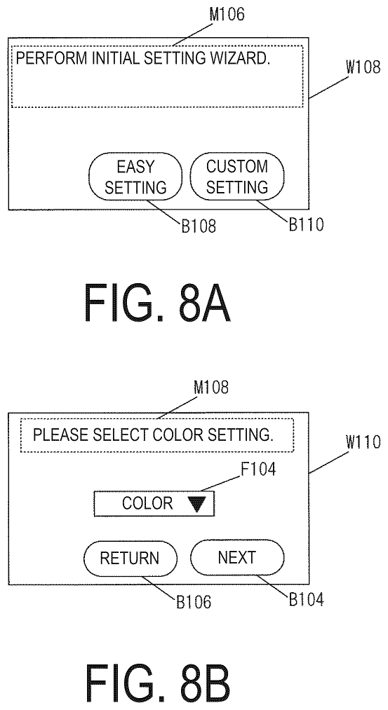

FIGS. 7A to 7D, 8A, and 8B are diagrams each illustrating one example of a display screen including a message displayed for a user as a result of operation of the image forming apparatus 10 according to the present embodiment.

### Description of Screens

FIG. 7A is a diagram illustrating one example of a display screen W100 displayed on the display 140 of the image forming apparatus 10. The display screen W100 serves as one example of a display screen in a case where the external storage device 20 is coupled and the setting information stored in the external storage device 20 can be imported at the time of the first startup of the image forming apparatus 10 that is in a state of factory settings, for example.

The display screen W100 displays a message M100 “Setting is available to import. Do you wish to import it?” In addition, the display screen W100 displays a YES button B100 and a NO button B102. The YES button B100 is a button used to give an instruction to import the setting information stored in the external storage device 20 into the image forming apparatus 10. The NO button B102 is used to cancel the performance of importing of the setting information stored in the external storage device 20 into the image forming apparatus 10. When the YES button B100 is selected, importing of the setting information starts. When the NO button B102 is selected, a display screen W108 (initial wizard-performing screen) in FIG. 8A that will be described below is displayed.

FIGS. 7B and 7C are diagrams each illustrating one example of the initial setting screen (display screen) displayed for a user when the image forming apparatus 10 performs an initial setting. FIG. 7B is one example of a display screen W102 used to set a language. In FIG. 7B, a message M102 “Please select language” is displayed. In addition, in the display screen W102, a language setting input form F100 that makes it possible to select a language setting is displayed, for example. In the language setting input form F100, the controller 100 provides pull-down display, for example, so as to be able to select a language such as Japanese, English, Chinese, or Korean. In addition, a NEXT button B104 is displayed on the display screen W102. The NEXT button B104 is a button used to give an instruction to display the next (the following) display screen. Once the NEXT button B104 is selected, a display screen W104 in FIG. 7C that will be described below is displayed, for example.

FIG. 7C is a diagram illustrating one example of the initial setting screen (display screen) displayed on the display 140 when the image forming apparatus 10 performs the initial setting. FIG. 7C is one example of the display screen W104 used to set an administrator password, and a message M104 “Please set administrator password” is displayed. In addition, in the display screen W104, an administrator-password input form F102 that makes it possible to input an administrator password is displayed, for example. Furthermore, a NEXT button B104 and a RETURN button B106 are displayed on the display screen W104. The NEXT button B104 is a button used to give an instruction to display the next (following) display screen. The RETURN button B106 is a button used to give an instruction to display the preceding display screen. When the NEXT button B104 is selected, a display screen W106 in FIG. 7D that will be described below is displayed, for example. When the RETURN button B106 is selected, the display screen W102 in FIG. 7B is displayed, for example.

FIG. 7D is a diagram illustrating one example of a display screen W106 displayed on the display 140 of the image forming apparatus 10. The display screen W106 is an operation screen that the image forming apparatus 10 normally displays, and makes it possible to select functions (modes) concerning performing a job. In addition, the display screen W106 serves as one example of a home screen (display screen) displayed in a case where the image forming apparatus 10 completes the initial setting.

Icons used to select a function (mode) concerning performing various types of jobs such as copying, fax, scanning, or the like are displayed in a region R100 of the display screen W106. The display screen W106 is a home screen displayed on the display 140 in a case where the initial setting completes, for example.

FIG. 8A is a diagram illustrating one example of a display screen W108 displayed on the display 140 in a case where the image forming apparatus 10 performs the initial setting. The display screen W108 serves as one example of a display screen displayed in S118 in FIG. 5, for example. A message M106 “Perform initial wizard” is displayed on the display screen W108. In addition, an easy setting button B108 and a custom setting button B110 are displayed on the display screen W108. The easy setting button B108 is a button used to give an instruction to perform the initial setting concerning a setting item (for example, an essential setting item) that is a portion of the setting items that can be set in the initial setting. The custom setting button B110 is a button used to give an instruction to perform the initial setting concerning more setting items (for example, all the setting items) that can be set in the initial setting, than the easy setting. In a case where the easy setting button B108 is selected, the initial setting including language setting and administrator password setting is performed, for example. In a case where the custom setting button B110 is selected, the initial setting including the color setting in addition to the language setting and the administrator password setting is performed, for example.

FIG. 8B is a diagram illustrating one example of a setting screen (display screen) displayed on the display 140 in a case where the image forming apparatus 10 performs the initial setting, and a message M108 “Please select color setting” is displayed. In addition, a color-setting input form F104 that makes it possible to select color setting is displayed in the display screen W110, for example. When a user selects the color-setting input form F104, the controller 100 causes a monochrome to be displayed as another option of color with pull-down display, for example. In addition, a NEXT button B104 and a RETURN button B106 are displayed on the display screen W110. The NEXT button B104 is a button used to give an instruction to display the next (following) display screen. The RETURN button B106 is a button used to give an instruction to display the preceding display screen. In a case where the NEXT button B104 is selected, the display screen W106 in FIG. 7D is displayed, for example. In a case where the RETURN button B106 is selected, the display screen W108 in FIG. 8A is displayed, for example.

### First Operation Example

As operation examples indicating the first embodiment, description will be made of a case where the initial setting of the image forming apparatus 10 is performed in terms of the following three setting items. Note that, in the operation examples, the initial setting is performed under the same conditions, unless otherwise specified.
Setting item: “language setting”
Type: “system” essential item: TRUE
Initial value: “Japanese” selectable setting value: “Japanese” “English” “Chinese” “Korean” and the like
Setting item: “administrator password”
Type: “system” essential item: TRUE
Initial value: “null”
Setting item: “monochrome/color”
Type: “job”
Initial value: “color” Selectable setting value: “color” “monochrome”

The first operation example is an operation example in a case where the setting information is not acquired from the external storage device 20. A user activates the image forming apparatus 10 without coupling the external storage device 20. The controller 100 first displays the display screen (initial setting screen) W108 in FIG. 8A. For example, when the user selects the easy setting button B108, the controller 100 displays the display screen W102 in FIG. 7B. For example, when the user selects “Japanese” as the language setting in the language setting input form F100 and then, selects the NEXT button B104, the controller 100 displays the display screen W104 in FIG. 7C. Next, when the user inputs, for example, “admin” as the administrator password in the administrator-password input form F102, and then, selects the NEXT button B104, the controller 100 displays the display screen W106 in FIG. 7D. Note that, when the user selects the RETURN button B106 in FIG. 7C, the controller 100 displays the display screen W102 in FIG. 7B.

On the other hand, when the user selects the custom setting button B110 in the display screen W108 in FIG. 8A, the controller 100 displays the display screen W102 in FIG. 7B and the display screen W104 in FIG. 7C, and then, displays the display screen W110 in FIG. 8B. When the user selects, for example, “color” as the color setting in the color-setting input form F104 and then, selects the NEXT button B104, the controller 100 displays the display screen W106 in FIG. 7D. Note that, when the user selects the RETURN button B106 in FIG. 8B, the controller 100 displays the display screen W104 in FIG. 7C.

In this manner, when the initial setting is performed without coupling the external storage device 20, the controller 100 determines that the external storage device 20 is not coupled, and performs the initial setting in which importing is not performed. The controller 100 causes the initial setting screen to be displayed on the display 140. Note that the user may make selection such that only the essential item is set, for example. In this case, the controller 100 performs the initial setting only for “language setting” and “administrator password,” for which essential item is “TRUE,” and determines that the setting values of both “language setting” and “administrator password” are the initial values. The controller 100 causes a dialog to be displayed to cause a user to input a setting value for the setting item for which the essential item is determined to be not yet set. The controller 100 stores “Japanese” to the setting value for the setting item “language setting,” and stores “admin” to the setting value for the setting item “administrator password.” Here, the controller 100 sets the setting item “monochrome/color” to “color” that is the initial value without changing, and ends the initial setting.

### Second Operation Example

The second operation example is an operation example in a case where the setting value “admin” for the setting item “administrator password” and the setting value “monochrome” for the setting item “monochrome/color” are stored in the setting information of the external storage device 20.

In this case, the setting value for the setting item “language setting” that is the essential setting item of the image forming apparatus 10 is not included in the setting information of the external storage device 20. Thus, even in a case where the setting information is imported from the external storage device 20 in the initial setting process of the image forming apparatus 10, the setting value for “language setting” is not set even though this is the essential setting item.

For this reason, the image forming apparatus 10 displays the display screen W102 in FIG. 7B in order to cause the user to set the setting value for the “language setting.” In addition, in the second operation example, the image forming apparatus 10 can complete the initial setting process without displaying the setting screen (FIG. 7C and FIG. 8B) including the setting item for which importing has already been done and the setting value has been reflected.

### Third Operation Example

The third operation example is an operation example in a case where the setting value “Japanese” for the setting item “language setting” and the setting value “admin” for the setting item “administrator password” are stored in the setting information of the external storage device 20.

In this case, the setting information of the external storage device 20 includes all setting values for the setting items that are the essential setting items of the image forming apparatus 10. Thus, as the image forming apparatus 10 imports the setting information from the external storage device 20, the necessary setting values are stored (reflected) in the setting-information storage region 1105. For this reason, in the third operation example, the image forming apparatus 10 can complete the initial setting process without displaying the intermediate setting screens (FIG. 7B, FIG. 7C, and FIG. 8B).

In addition, in the present embodiment, the setting information acquired from the external storage device 20 includes the system setting information and the job setting information. Here, for example, the setting information acquired from the external storage device 20 may include only the system setting information.

Furthermore, for example, the processes from S106 to S110 in the operation flow of FIG. 5 may be performed after S112 is performed. In this case, the setting information acquired from the external storage device 20 is stored, for example, in XML or the like. In addition, the controller 100 acquires the setting information including property information concerning the essential item as a tag of the property, and temporarily stores the acquired setting information in the storage 110. Next, the controller 100 performs the process of S112, and reflects the setting information acquired from the external storage device 20 instead of the setting information stored in the system setting-information storage region 1110. This makes it possible to perform the processes of S106 to S110 in the operation flow of FIG. 5 after S112.

### 1.6 EFFECTS AND THE LIKE

In this manner, the controller 100 determines the essential items in the setting information. In addition, the controller 100 determines whether or not the setting item determined to be the essential item has already been set. The controller 100 notifies a user when the two determinations described above are met. The controller 100 does not notify the user of notifications other than this notification because these are regarded as being less important. With this configuration, the user can check only necessary notifications. This makes it possible to reduce the burden of checking. In addition, it is possible to reduce overlooking of the notification by the user, which makes it possible to prevent omission of setting of the essential items.

In addition, in a case where a USB flash drive that stores the setting information (for example, import file) is inserted into the device at the time of initial startup, the user imports the setting information before the initial setting screen such as a setting screen is displayed. The controller 100 can change the initial setting screen displayed in accordance with details of the importing. This makes it possible to reduce the period of time when the user operates, and also possible to prevent omission of setting of the essential items. In a case where the setting value for the essential item has already been set through importing, it is possible to skip (omit) this setting item on the initial setting screen, which makes it possible to reduce the time when the user operates.

### 2. Second Embodiment

Below, a second embodiment will be described. The second embodiment makes it possible to notify a user in a case where a non-recommended setting value is included in the setting information.

The second embodiment will be described with focus being placed on points differing from the first embodiment, and portions having the same hardware configuration and the same software configuration as those in the first embodiment will not be described.

### 2.1 Software Configuration

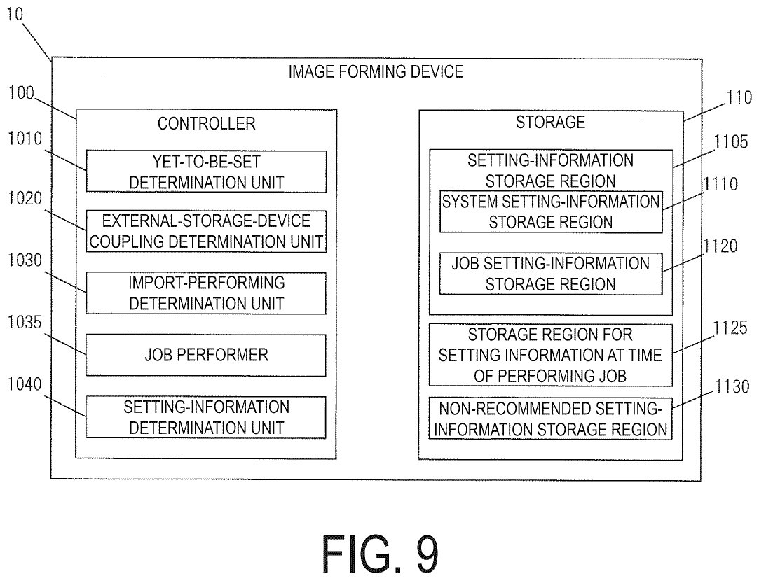

The configuration of main software in each device of the system 1 will be described with reference to FIG. 9. FIG. 9 is a diagram illustrating the software configuration of the image forming apparatus 10. Note that the software configurations illustrated in FIG. 9 are main configurations necessary in the present embodiment, and the other configurations are not illustrated.

### 2.1.1 Image Forming Apparatus

First, the main software configuration of the image forming apparatus 10 will be described. The controller 100 reads and performs a program stored in the storage (the storage 110 and the ROM 120), thereby being able to achieve a setting-information determination unit 1040.

The setting-information determination unit 1040 makes comparison with a setting value stored in the non-recommended setting-information storage region 1130 to determine whether or not a non-recommended setting value is stored in a setting value corresponding to a setting item stored in the setting-information storage region 1105. Here, the non-recommended setting value is a non-recommended setting value that is not recommended as a setting value in terms of security, for example. One example of the non-recommended setting value includes a setting value based on an old standard and a setting value for which vulnerability is found.

The storage 110 stores a non-recommended setting value for the setting item described above in the non-recommended setting-information storage region 1130 as non-recommended setting information.

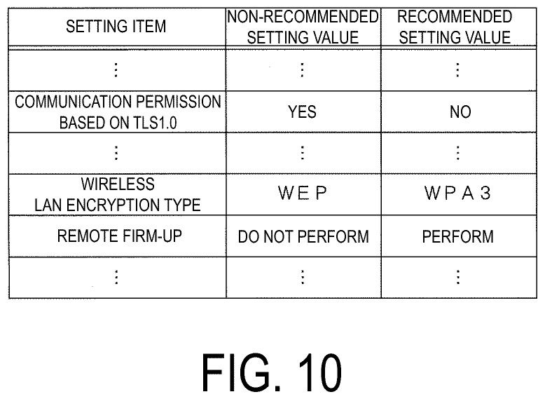

Here, one example of the non-recommended setting information stored in the non-recommended setting-information storage region 1130 will be described with reference to FIG. 10. A setting item (for example, “communication permission based on TLS1.0”) based on the setting information of the image forming apparatus 10 and a non-recommended setting value (for example, “YES”) are stored. In addition, the non-recommended setting-information storage region 1130 may store a recommended setting value (for example, “NO”) on an as-necessary basis. Note that one or a plurality of values may be stored as the setting value.

### 2.2 Processing Flow

### 2.2.1 Non-Recommendation Determination Process

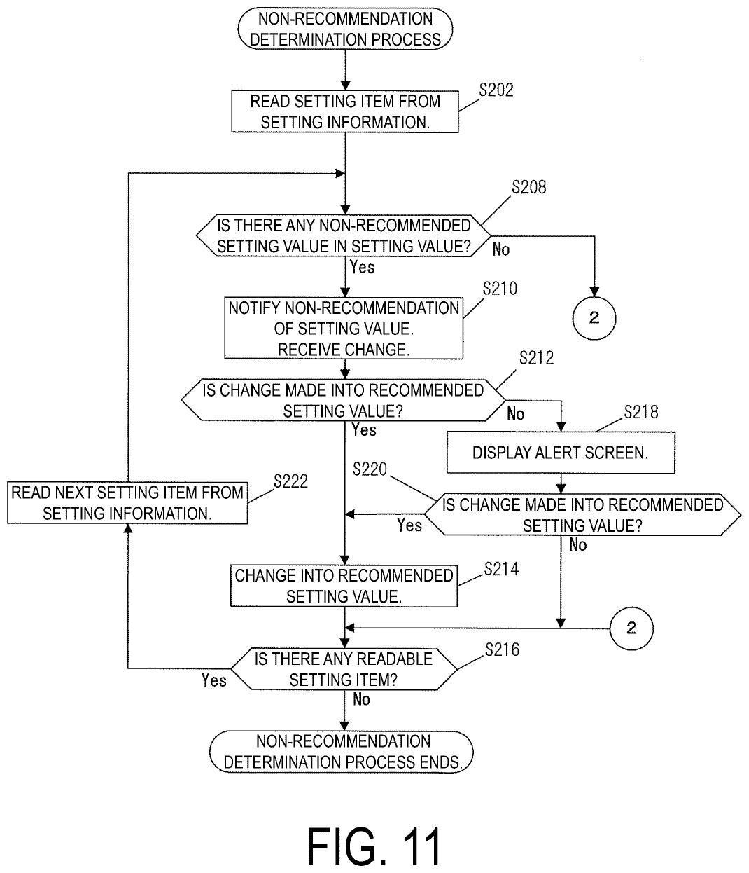

FIG. 11 is a diagram illustrating the non-recommendation determination process according to the present embodiment. FIG. 11 shows processes performed after S112 in FIG. 5 in the first embodiment. By performing these processes, the controller 100 determines whether or not there is any non-recommended value in setting values set in the setting information. In addition, when there is any non-recommended setting value, the controller 100 performs a process of displaying an alert or a process of changing this non-recommended setting value into a recommended setting value. Below, one example will be described.

First, the controller 100 reads the setting information stored in the setting-information storage region 1105 (S202). The controller 100 determines whether the setting value for the setting item included in the setting information is a non-recommended setting value (S208).

Here, for example, the following method can be employed for the controller 100 to determine whether or not the setting value for the setting item included in the setting information is a non-recommended setting value.

First, the controller 100 reads the non-recommended setting information from the non-recommended setting-information storage region 1130.

Then, for example, by making comparison, the controller 100 determines whether or not the setting item included in the setting information read in S202 is included in setting items of the non-recommended setting information.

When determining that the setting information includes the setting item included in the non-recommended setting information, the controller 100 causes the setting-information determination unit 1140 to determine whether or not the setting value is a non-recommended setting value. For example, it may be possible to employ a configuration in which, when a setting value included in the setting information and a non-recommended setting value included in the non-recommended setting information match each other, the controller 100 determines that the setting value for the setting item in the setting information is the non-recommended setting value. Alternatively, for example, it may be possible to employ a configuration in which, in a case where a setting value differing from the recommended setting value is set for a setting item (a setting value that does not match a recommended setting value), the controller 100 determines that the setting value is the non-recommended setting value.

When determining that the setting value in the setting information is the non-recommended setting value, the controller 100 notifies a user that the setting value is a non-recommended setting value, and receives a change in the setting value from the user (S208; Yes→S210). In addition, as the setting screen used to set (change) the setting value, the controller 100 may cause the display 140 to display, as a change confirmation screen, a display screen that makes it possible to change the setting value including the recommended setting value read out from the non-recommended setting-information storage region 1130, for example.

Then, the controller 100 determines whether or not an operation of changing the setting value in the setting information into the recommended setting value is performed (S212). In addition, when determining that the operation of changing the setting value in the setting information into the recommended setting value is performed, the controller 100 changes the setting value in the setting information into the recommended setting value in the non-recommended setting information (S212; Yes→S214).

When determining that the operation of not changing the setting value in the setting information into the recommended setting value is performed, the controller 100 displays an alert screen (display screen) including a notification alerting that the setting value is a non-recommended setting value (S212; No→S218).

Next, for example, the controller 100 receives a change of setting again, and determines whether or not to change the setting value into a recommended setting value (S220). In a case of changing the setting value into a recommended setting value, the controller 100 changes the setting value into a recommended setting value (S220; Yes→S214).

In addition, when it is determined that the setting value is not a non-recommended setting value (S208; No), or when an operation of not changing the setting value into a recommended setting value is not performed (S220; No), determination is made as to whether or not there is a readable setting item (S216). Here, the controller 100 may make determination in a manner similar to that in the yet-to-be-set determination process in S152, for example.

When determining that there is a readable setting item, the controller 100 reads the setting information such as the next setting item that has not yet been read from the setting-information storage region 1105 (S216; Yes→S222). Here, when the controller 100 determines there is no readable setting item, the initial setting process ends (S216; No).

Note that the operation flow described above is merely one example, and a partially differing process may be performed. In the present embodiment, for example, the process is performed after the process of S112. However, it may be possible to change the order of the flow and perform the process before S112.

### 2.3 Operation Example

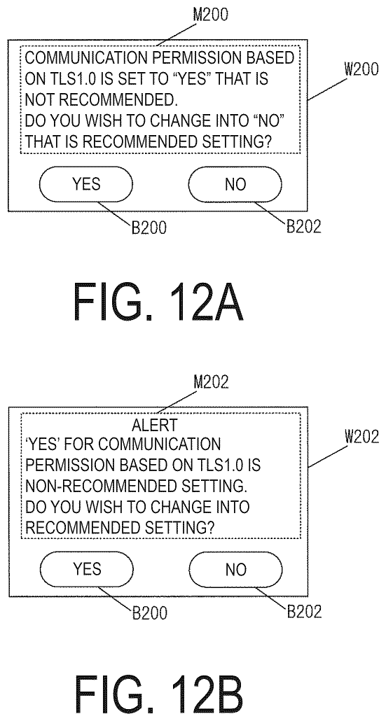

FIGS. 12A and 12B are diagrams illustrating one example of a display screen including a message displayed for a user concerning a result of operation of the image forming apparatus 10 according to the present embodiment.

FIGS. 12A and 12B are diagrams each illustrating one example of a display screen displayed on the display 140 of the image forming apparatus 10. A display screen W200 in FIG. 12A is a diagram illustrating one example of a change confirmation screen (display screen) including a message displayed for a user in a case where there is a non-recommended setting value in setting values included in the setting information stored in the external storage device 20, for example.

The display screen W200 includes a message M200 “Communication permission based on TLS1.0 is set to ‘YES’ that is not recommended. Do you wish to change into ‘NO’ that is recommended setting?” In addition, the display screen W200 displays a YES button B200 and a NO button B202.

Here, when the user selects the YES button B200, the controller 100 stores “NO” as the setting value for the setting item “Communication permission based on TLS1.0” stored in the system setting-information storage region 1110. In addition, for example, when there is another non-recommended setting value, the controller 100 displays a display screen again in which there is a non-recommended setting value. On the other hand, when the user selects the NO button B202, a display screen W202 in FIG. 12B is displayed.

The display screen W202 in FIG. 12B is a diagram of one example of an alert screen. The display screen W202 displays a message M202 “‘YES’ for communication permission based on TLS1.0 is a non-recommended setting. Do you wish to change into recommended setting?” In addition, the YES button B200 and the NO button B202 are displayed on the display screen W202. Here, when the user selects the YES button B200, the same process as in FIG. 12A is performed. On the other hand, when the user selects the NO button B202, the controller 100 displays the display screen W106 serving as a home screen if there is no other non-recommended setting value, for example. Note that the controller 100 may repeatedly display an alert screen until the user changes the setting value into a recommended setting value, for example.

### 2.4 Effects and the Like

In this manner, the controller 100 determines whether or not the setting value is a non-recommended setting value. When the setting value is a non-recommended setting value, the controller 100 notifies a user, and displays the change confirmation screen that makes it possible to change the setting value into a recommended setting value. This configuration prevents a user from performing reflection (setting) without noticing the non-recommended setting value or from operating with a non-recommended setting value as it is. Thus, for example, in a case where the non-recommended setting value is a value that is not recommended in terms of security, it is possible to prevent the image forming apparatus from being exposed to security threats.

### 3. Third Embodiment

Below, a third embodiment will be described. The third embodiment can determine whether or not a password in the acquired setting information is a non-recommended setting value that does not meet a password policy, and can check the acquired password with a user.

The third embodiment will be described with focus being placed on points differing from the first embodiment, and portions having the same hardware configuration and the same software configuration as those in the first embodiment will not be described.

### 3.1 Software Configuration

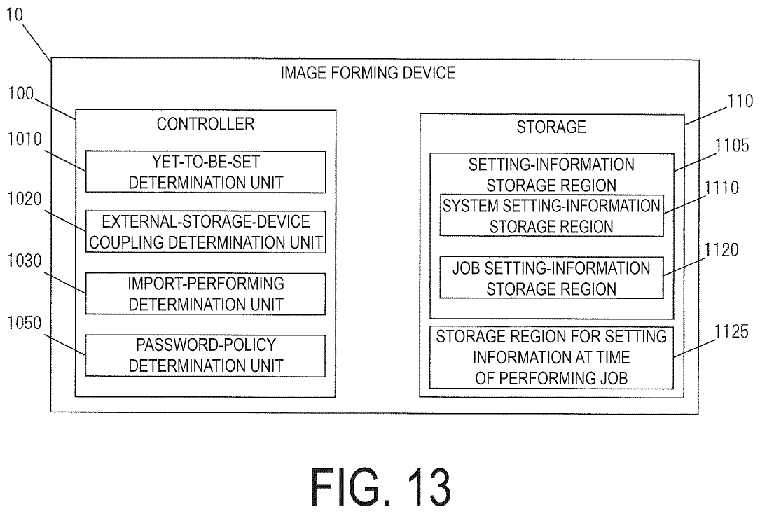

The main software configuration of each of the devices in the system 1 will be described with reference to FIG. 13. FIG. 13 is a diagram illustrating the software configuration of the image forming apparatus 10. Note that the software configurations illustrated in FIG. 13 are main configurations necessary in the present embodiment, and the other configurations are not illustrated.

### 3.1.1 Image Forming Apparatus

First, the main software configuration of the image forming apparatus 10 will be described. For example, the controller 100 reads a program stored in the storage (the storage 110 and the ROM 120) to perform it, thereby being able to achieve a password-policy determination unit 1050.

The password-policy determination unit 1050 determines whether or not the setting value for the setting item concerning a password meets a password policy. Here, the password policy is a condition of characters that constitute the password recommended in terms of security. In the following cases, the password-policy determination unit 1050 may determine that the setting value meets the password policy.
a case where the number of character types included in the setting value satisfies the predetermined number, for example, a case where the character types are set to include both an alphabet and a numeral, and one or more characters of each of the alphabet and the numeral is included in the setting value.
a case where the character length of the setting value is longer than the predetermined character length, for example, a case where the character length is set to five characters, and the character length of the setting value is equal to or more than six characters.
a case where the character type included in the setting value includes characters that can be used by the image forming apparatus 10, for example, the character type is made of characters that do not include Japanese kanji characters, special characters, or the like.

### 3.2 Processing Flow

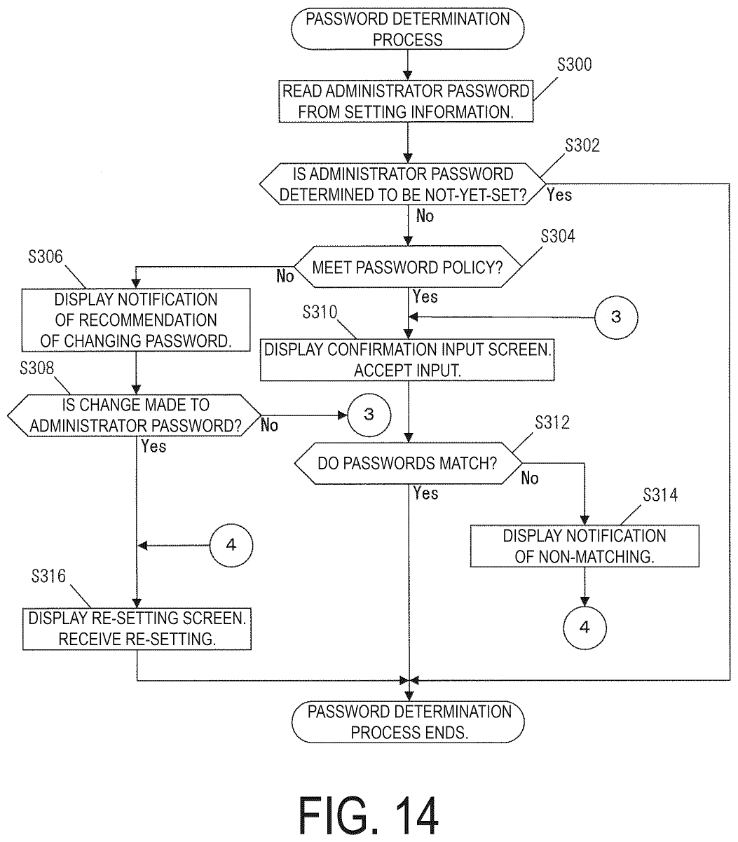

FIG. 14 is a diagram used to describe the flow of a password determination process according to the present embodiment. The password determination process is a process performed after S112 of FIG. 5 according to the first embodiment.

First, the controller 100 reads information concerning the setting item of an administrator password and the setting value from the setting item stored in the setting-information storage region 1105 (S300).

Next, the controller 100 determines whether or not the administrator password has already been set (S302). The controller 100 may cause the yet-to-be-set determination unit 1010 to make determination as in S110, for example.

When not determining that the administrator password has not yet been set, the controller 100 causes the password-policy determination unit 1050 to makes comparison with a condition (password policy) of a character that constitutes a password to determine whether or not it meets the password policy (S302; No→S304).

When determining that it does not satisfy the password policy, the controller 100 causes the display 140 to display a display screen that includes a notification of recommendation of changing the password and allows changing of the password to be selected (S304; No→S306).

Next, the controller 100 determines whether or not to change the administrator password (S308). When determining that the administrator password is not changed (S308; No) or when determining that it meets the password policy (S304; Yes), the controller 100 causes the display 140 to display a confirmation input screen (display screen) that allows a user to input the administrator password to receive input from the user (S310).

Next, the controller 100 determines whether or not the passwords match (S312). For example, the controller 100 compares the setting value for the setting item concerning the administrator password with the value of the administrator password that the user inputs in the confirmation input screen to determine whether or not both passwords match each other. Here, when determining that the passwords do not match, the controller 100 causes the display 140 to display that the administrator password does not match (S312; No→S314).

Next, the controller 100 displays a re-setting screen as the setting screen to receive re-setting (S316). In addition, when determining that the administrator password is changed, the controller 100 displays the re-setting screen to receive re-setting (S308; Yes→S316). The controller 100 causes the display 140 to display a display screen that allows a user to input an administrator password, as the re-setting screen, for example. Here, when the user inputs the administrator password, the controller 100 stores, to the setting value, the administrator password input by the user.

On the other hand, when determining the passwords match, the controller 100 ends the password determination process (S312; Yes).

Note that the operation flow described above is merely one example, and it may be possible to perform partially differing processes. The present embodiment describes the operation flow of the password determination process in FIG. 14 as a process performed after S112 of FIG. 5 according to the first embodiment. However, for example, this process may be a process performed before S112 of FIG. 5. In addition, the operation flow of the non-recommendation determination process of FIG. 11 according to the second embodiment may be performed after the flow of the password determination process of FIG. 14, or between S112 and the operation flow of the password determination process of FIG. 14.

### 3.3 Operation Example

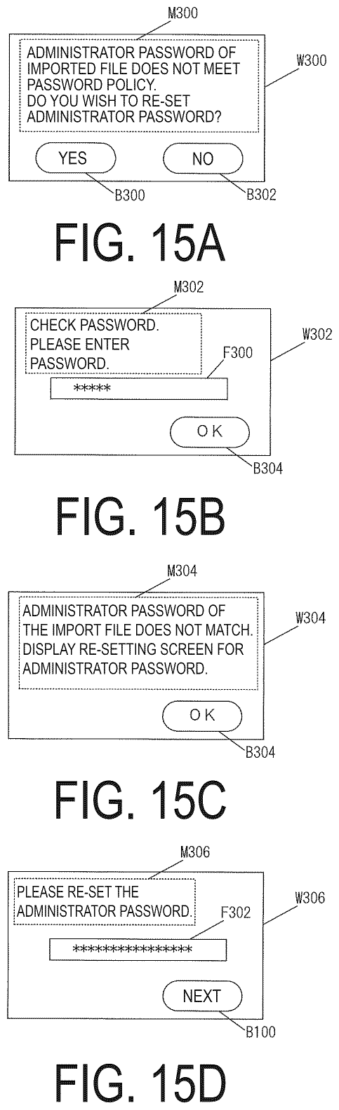

FIGS. 15A to 15D are diagrams illustrating one example of a display screen including a message displayed for a user concerning a result of operation of the image forming apparatus 10 according to the present embodiment.

FIGS. 15A, 15B, 15C, and 15D are diagrams each illustrating one example of a display screen displayed on the display 140 of the image forming apparatus 10. The display screen W300 in FIG. 15A is a diagram illustrating one example of a display screen including a message displayed for a user in a case where the setting value of the administrator password included in the setting information stored in the external storage device 20 does not meet the password policy.

The display screen W300 displays a message M300 “Administrator password of imported file does not meet password policy. Do you wish to re-set administrator password?” In addition, the display screen W300 also displays a YES button B300 and a NO button B302. Here, when a user selects the YES button B300, the controller 100 displays a display screen W306 in FIG. 15D. On the other hand, when the user selects the NO button B302, the controller 100 displays a display screen W302 in FIG. 15B.

The display screen W302 in FIG. 15B is a diagram illustrating one example of a display screen including a message displayed for a user in a case where the setting value of the administrator password included in the setting information stored in the external storage device 20 meets the password policy. The display screen W302 displays a message M302 “Check password. Please enter password.” In addition, the display screen W302 displays an administrator-password input form F300 that makes it possible to input an administrator password and an OK button B304.

Here, the user inputs an administrator password into the administrator-password input form F300, and selects the OK button B304. For example, when the administrator password entered by the user matches the setting value included in the setting information and the essential item has not yet been set, the controller 100 displays the display screen W106 serving as the home screen. On the other hand, when the administrator password entered by the user does not match, for example, the setting value included in the setting information, the controller 100 displays a display screen W304 in FIG. 15C.

The display screen W304 in FIG. 15C is a diagram illustrating one example of a display screen including a message displayed for a user in a case where the administrator password entered by the user does not match the setting value included in the setting information, for example. The display screen W304 displays a message M304 “Administrator password of imported file does not match. Re-setting screen for administrator password is displayed.” In addition, the display screen W304 displays the OK button B304. Here, when the user selects the OK button B304, the controller 100 displays the display screen W306 in FIG. 15D.

The display screen W306 in FIG. 15D is a diagram illustrating one example of a display screen including a message displayed for a user in a case where the administrator password entered by the user does not match the setting value included in the setting information or where the user re-sets the administrator password, for example.

The display screen W306 displays a message M306 “Please re-set administrator password.” In addition, the display screen W306 displays an administrator-password input form F302 that makes it possible to input an administrator password, and a NEXT button B100. Here, the user inputs the administrator password into the administrator-password input form F302, and selects the NEXT button B100. For example, when the essential item is not yet set, the controller 100 displays the display screen W106 serving as the home screen.

Note that, in the present embodiment, the password input in each of the input forms is not shown (for example, is replaced with “*”) such that details of the input password cannot be known through the display screen. However, the input password may be displayed so as to be able to be known through the display screen. In addition, it may be possible to display, on the display screen, a switching button that allows a user to switch between displaying and not displaying the password.

Note that the present embodiment gives an example in which determination is made as to the password policy for the administrator password. However, this is applicable to other passwords, for example.

### 3.4 Effects and the Like

In this manner, for example, in a case where the setting value such as a password is stored, the controller 100 can determine whether or not the password is a non-recommended setting value that does not meet the password policy, for example. In a case where the password does not meet the password policy, the controller 100 makes notification to that effect. This prevents a user from not noticing that the password does not meet the password policy and operating the image forming apparatus in a state of being less secure in terms of security.

In addition, it is possible to cause the password to be re-entered for the purpose of checking. This enables the user to set the password stored in the setting information with the user checking it. For example, it is possible to prevent the user from setting the administrator password in a state of forgetting the password. It is possible to prevent the user from re-performing the initial setting or performing initialization of the password due to the user forgetting the password.

### 4. Modification Examples

The present disclosure is not limited to the embodiments described above, and various modifications are possible.

In other words, embodiments obtained by combining technical mechanisms appropriately changed without departing from the gist of the present disclosure are also included in the technical scope.

The embodiments described above describe the image forming apparatus as an example of the information processing apparatus. However, it is possible to apply the information processing apparatus to other devices. For example, one example of the information processing apparatus includes an information processing apparatus such as a smartphone or a tablet. Furthermore, it may be a home appliance (for example, an air conditioner, a refrigerator, a television, or the like) having an IoT function. In addition, the information processing apparatus is not limited to a stationary device, and may be a portable device or an in-vehicle device, for example. For example, the in-vehicle device may be a device such as a car navigation system.

Furthermore, the embodiments have been separately described for the purpose of convenience of description. However, the embodiments can be combined and executed within an allowable range. Right acquisition is intended for any of the technologies described herein through amendment, divisional application, or the like.

Furthermore, the programs running on each of the devices in each of the embodiments are programs for controlling a CPU or the like (programs for causing a computer to function) to achieve the functions in the embodiments described above. In addition, information handled by these devices is temporarily accumulated in a transitory storage device (for example, a RAM) at the time of processing, is then held in a storage device such as any of various types of ROM or an HDD, and is read, corrected, and written by the CPU as needed.

Here, the recording medium that holds the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In addition, in a case where programs are distributed to the market, the programs can be stored and distributed in a portable recording medium, or can be transferred to a server computer coupled via a network such as the Internet. In this case, it is needless to say that the storage device of the server device is also included in the present disclosure.

Furthermore, instead of being stored in the device, the above-described data may be stored in an external device and be called on an as-necessary basis. For example, the data may be stored in a Network Attached Storage (NAS) or may be stored on a cloud.

It should be noted that the scope of the present disclosure is not limited to the configurations explicitly described herein, and a combination of technologies disclosed herein is also included in the scope thereof. Of the present disclosure, the configurations sought to be patented are set forth in the appended claims. However, configurations that are not stated in the claims are not intended to be excluded from the technical scope.

Furthermore, in the present description above, the wordings “in a case where . . . ” and “when . . . ” are described as examples, and the configuration is not limited to the described contents. Configurations not indicated by the descriptions “in a case where . . . ” and “when . . . ” are also disclosed to the extent that the configurations are obvious to a person skilled in the art, and the rights of these configurations are intended to be acquired.

As for the processes and the flows of data that have been described herein with order, the order thereof is not limited to the described order. For example, a configuration in which a portion of the processes is removed or the order is re-arranged is also intended to be disclosed, for which the right is intended to be acquired.

Although the functions described in the embodiments are described as being performed in the respective devices, the functions may be implemented in one device or using an external server. Furthermore, in the embodiments described above, the functions are described to be performed in each of the devices. However, these functions may be achieved in one device, and an external server may be used.

In addition, each functional block or various features of the devices used in the embodiments described above can be implemented or performed by an electric circuit such as an integrated circuit or a plurality of integrated circuits, for example. An electric circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof. A general-purpose processor may be a microprocessor, or any known processor, controller, micro-controller, or state machine. The electric circuit described above may be configured by a digital circuit or an analog circuit. In addition, in a case where an integrated circuit technology that replaces the current integrated circuit becomes available due to advancement of the semiconductor technology, one or more aspects of the present disclosure can use the new integrated circuit based on the new integrated circuit technology.

1. An information processing apparatus comprising:
a display;
one or more storages that store a setting item and a setting value in an associated manner; and
one or more controllers that acquire a setting value corresponding to the setting item from an external storage device to set the acquired setting value to the setting value stored in the one or more storages, wherein
in a case where the setting value corresponding to a specific setting item of the setting item stored in the one or more storages are not yet set, the one or more controllers cause the display to display a setting screen used to set the setting value that has not yet been set.

2. The information processing apparatus according to claim 1, wherein
the setting item further includes a property,
the one or more controllers determine that the setting item is the specific setting item, on a basis of the property, and
in a case where the setting value corresponding to the specific setting item is not yet set, the one or more controllers cause the setting screen to be displayed.

3. The information processing apparatus according to claim 2, further comprising:
a job performer that performs a job, wherein
the setting item includes:
a system setting item that is a setting item concerning a system of the information processing apparatus; and
a job setting item that is a setting item concerning the job,
the one or more controllers determine, on a basis of the property, that the setting item from among the setting item corresponding to the system setting item is an essential setting item, and
in a case where the setting value corresponding to the essential setting item is not yet set, the one or more controllers cause the setting screen to be displayed.

4. The information processing apparatus according to claim 3, wherein
the system setting item includes at least the setting item concerning any one of a setting item of an administrator password and a setting item of a network, and
the one or more controllers determine that the setting item of the administrator password and the setting item of the network are essential setting items.

5. The information processing apparatus according to claim 2, wherein
the one or more storages store information concerning a recommended setting value so as to correspond to the setting item, and
when the set setting value differs from the recommended setting value, the one or more controllers cause the display to display a setting screen used to set the setting value including the setting value that differs from the recommended setting value.

6. The information processing apparatus according to claim 5, wherein
as the setting screen, the one or more controllers display a confirmation screen that makes it possible to change from the set setting value into the recommended setting value.

7. The information processing apparatus according to claim 5, wherein
the one or more storages further store information concerning a non-recommended setting value so as to correspond to the setting item, and
the one or more controllers displays the setting screen concerning a setting item corresponding to the setting value that matches the non-recommended setting value.

8. The information processing apparatus according to claim 1, wherein
the one or more controllers determine that the setting value is not yet set, on a basis of any one state of a state where the setting value is not stored and a state where the setting value is not changed from an initial value.

9. A setting method including:
a displaying step;
a storing step of storing a setting item and a setting value in an associated manner;
a controlling step of acquiring a setting value corresponding to the setting item from an external storage apparatus to set the acquired setting value to the setting value stored in the storing step, wherein
in the controlling step, in a case where the setting value corresponding to a specific setting item of the setting item stored in the storing step is not yet set, a setting screen used to set the setting value that is not yet set is displayed in the displaying step.
